(19) United States
(12) Patent Application Publication
(10) Pub. No.: US 2002/0041442 A1
(43) Pub. Date: Apr. 11, 2002

(54) Vehicle rearview mirror system

(76) Inventor: Frank A. Witt, West Columbia, SC (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 09/808,428

(22) Filed: Mar. 14, 2001

Related U.S. Application Data
(60) Provisional application No. 60/189,105, filed on Mar. 14, 2000.
(60) Provisional application No. 60/234,746, filed on Sep. 22, 2000.

(51) Int. Cl. G09G 3/14; G02F 1/153; G02B 27/00; G02B 5/08; G02B 17/00

(52) U.S. Cl. 359/603; 359/267; 359/601; 359/866

(57) ABSTRACT

A vehicular rearview mirror system includes a rearview mirror assembly including a reflective element and a housing for the reflective element. The reflective element includes a plurality of reflective element segments. At least one of the reflective element segments is an electro-optic variable reflective element having a partial reflectance level that varies as a function of a drive signal. The vehicular rearview mirror system further includes directional light-sensing means for producing an output that varies as a function of a direction that light is sensed by the light-sensing means. The output is provided as a drive signal to the at least one of the reflective element segments. In this manner, the at least one of the reflective element segments has a partial reflectance level that is a function at least of direction that light is sensed by the light-sensing means.

### CROSS-REFERENCE TO RELATED APPLICATIONS

This application claims priority from U.S. provisional patent application Ser. No. 60/189,105, filed on Mar. 14, 2000, and U.S. provisional patent application Ser. No. 60/234,746, filed on Sep. 22, 2000, the disclosures of which are hereby incorporated herein by reference in their entirety.

### BACKGROUND OF THE INVENTION

The present invention relates to rearview mirror systems of a vehicle, such as an automobile, truck, motorcycle, and the like, and, in particular, to anti-glare devices to eliminate driver eyestrain and increased safety margins.

The automotive industry typically uses prism flip-type devices or a device that uses a darkening mechanism that establishes a partial reflectance level for bright headlights as they strike the reflectance element. This may be accomplished by utilization of a photodetector, such as a photocell, to sense when these lights are at some predetermined brightness, at which time a partial reflectance level is established.

### SUMMARY OF THE INVENTION

The present invention relates to maintaining at a high reflectance level as much of the rearview mirror surface as possible while eliminating specific points of light from trailing traffic. The present invention provides a microprocessor-based or, alternatively, a discrete component, smart variable reflectance mirror system. The mirror system has various types of sensors that operate automatically a wide range of solid-state devices for increasing rear viewing.

A vehicular rearview mirror system, according to an aspect of the invention, includes a rearview mirror assembly including a reflective element and a housing for the reflective element. The reflective element includes a plurality of reflective element segments. At least one of the reflective element segments is an electro-optic variable reflective element having a partial reflectance level that varies as a function of a drive signal. The vehicular rearview mirror system further includes directional light-sensing means for producing an output that varies as a function of a direction that light is sensed by the light-sensing means. The output is provided as a drive signal to the at least one of the reflective element segments. In this manner, the at least one of the reflective element segments has a partial reflectance level that is a function at least of direction that light is sensed by the light-sensing means.

Preferably, the light-sensing means is made up of a series of spatially arranged photosensors and an optic element that directs light to the photosensor array as a function of the direction that light passes through the optic element.

The directional light-sensing means provides better rear mirror capability by changing the partial reflectance level of two or more vertical segments or two or more horizontal segments for the purpose of attenuating light at any given segment of the mirror thereby providing additional viewing in clear segment zones unaffected by following headlights, or the like.

According to another aspect of the invention, a vehicular rearview mirror system includes at least one exterior rearview mirror assembly mounted at a side of the vehicle. The exterior rearview mirror assembly includes an exterior reflective element and an exterior mirror housing for the exterior reflective element. The system includes a blind spot detector for detecting other vehicles at the side of the vehicle and a signaling device. The signaling device emits a signal in response to the blind spot detector detecting another vehicle at the side of the vehicle. The signal is reflected by the other vehicle toward the driver of the equipped vehicle. The blind spot sensor will be activated by sensors, or manual devices, prior to entering a blind spot of the vehicle that is being passed by turning on a visual or aural signal to illuminate a portion of the side of the vehicle momentarily past in order to catch the attention of the driver of the equipped vehicle by reflection in the driver's exterior mirror or by receipt of the aural signal, such as a beeping sound at a frequency that is typically not in conflict with other outside sounds, such as wind, engine noise, precipitation, water standing on the highway, or the like.

According to yet another aspect, the present invention provides a vehicular rearview mirror system, including at least one rearview mirror assembly having an exterior reflective element and a mirror housing for the reflective element. The system includes an emergency vehicle detector for detecting an emergency vehicle and a control. The control establishes a partial reflectance level of the reflective element. The control is responsive to the emergency vehicle detector for establishing a high reflectance condition of the reflective element when the emergency vehicle detector detects an emergency vehicle. In this manner, the exterior mirror of the vehicle is placed in a high visibility condition in order to enhance the ability to view the emergency vehicle.

These and other objects, advantages and features of this invention will become apparent upon review of the following specification in conjunction with the drawings.

### BRIEF DESCRIPTION OF THE DRAWINGS

FIG. 1 is a top plan view of a vehicle equipped with a rearview mirror system, according to the invention;

FIG. 2 is a rear elevation of an interior rearview mirror system, according to the invention;

FIG. 3 is a perspective view of a directional light sensor assembly;

FIG. 4 is a top plan view of the directional light sensor assembly in FIG. 3;

FIG. 5 is a rear elevation of a photosensor array;

FIG. 6 is the same view as FIG. 5 of an alternative embodiment thereof;

FIG. 7 is the same view as FIG. 5 of an alternative embodiment thereof;

FIG. 8 is the same view as FIG. 2 of an alternative embodiment thereof;

FIG. 9 is a rear elevation of an exterior rearview mirror assembly, according to the invention;

FIG. 10 is a rear elevation of a truck or recreational vehicle mirror assembly;

FIG. 11 is the same view as FIG. 2 of an alternative embodiment thereof;

FIG. 12 is a block diagram of a control system useful with the invention;

FIG. 13 is a rear elevation of an interior rearview mirror assembly, according to the invention;

FIG. 14 is the same view as FIG. 13 of an alternative embodiment thereof;

FIG. 15 is the same view as FIG. 13 of an alternative embodiment thereof;

FIG. 16 is the same view as FIG. 13 of an alternative embodiment thereof;

FIG. 17 is the same view as FIG. 13 of an alternative embodiment thereof;

FIG. 18 is a rear elevation of an exterior rearview mirror assembly incorporating a blind spot detector illustrated in a mode in which traffic is detected in the vehicle's blind spot;

FIG. 19 is the same view as FIG. 18 in a mode without traffic detected in the vehicle's blind spot;

FIG. 20 is the same view as FIG. 18 of an alternative embodiment;

FIG. 21 is the same view as FIG. 18 of yet another alternative embodiment thereof;

FIG. 22 is a block diagram of a control system useful with the exterior rearview mirror assembly in FIGS. 20 and 21;

FIG. 23 is the same view as FIG. 18 of an alternative embodiment thereof, illustrated in a mode without traffic detected in the vehicle's blind spot;

FIG. 24 is a block diagram of a control useful with the mirror assembly in FIG. 23; and

FIG. 25 is the same view as FIG. 23 with the exterior rearview mirror assembly in an alternative mode of operation.

### DESCRIPTION OF THE PREFERRED EMBODIMENT

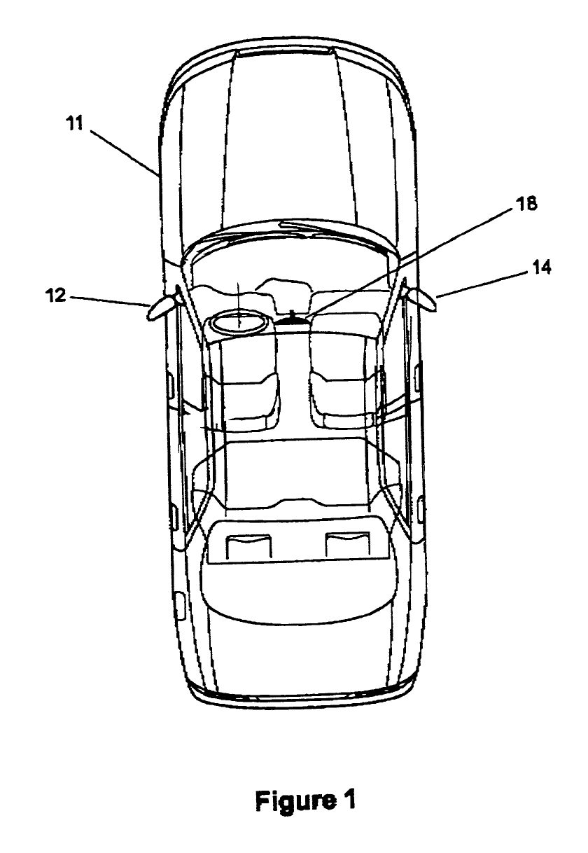

Referring now specifically to the drawings, and the illustrative embodiments depicted therein, a vehicular rearview mirror system 10 useful with a vehicle 11 includes an interior rearview mirror assembly 18 and at least one exterior rearview mirror assembly (FIG. 1). In the illustrative embodiment, the at least one exterior rearview mirror assembly includes a driver side exterior rearview mirror assembly 12 and a passenger side exterior rearview mirror assembly 14.

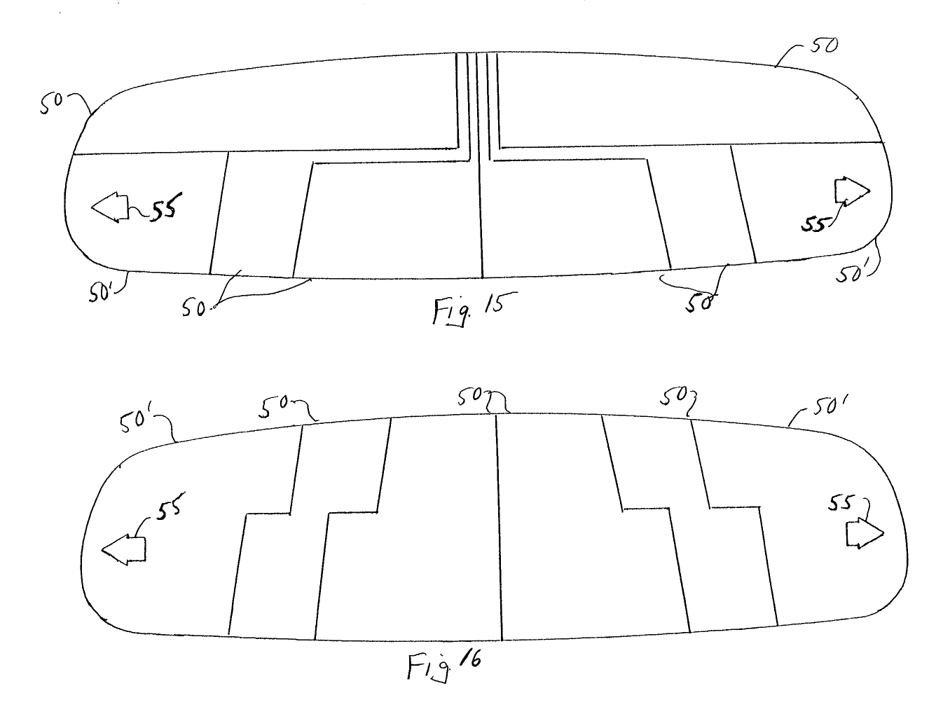

Vehicle rearview mirror system 10 further includes a control system 16 including at least one directional light-sensing means 20 which produces an output 22 which is combined with an output 24 of another light sensor 26 in a circuit 28 (FIG. 12). An output of circuit 28 is supplied as an input 30 to a driver controller 32. Driver controller 32 includes a plurality of outputs 34, each of which represents a drive signal whose purpose will be set forth in more detail below. It should be understood that a plurality of outputs 34 may be individual signals, or multiplexed in one of many known techniques. Preferably, light sensor 26 is not significantly sensitive to the direction of light received by light sensor 26. This may be accomplished, as is understood in the art, by a light sensor that faces away from the rear of the vehicle, such as forward of the vehicle or upwardly with respect to the vehicle. It should be understood that circuit 26, drive controller 32 and a power supply 36 may be discrete, analog, or digital components, or, preferably, are incorporated in a microprocessor-based controller of the type described in commonly assigned U.S. patent application Ser. No. 08/832,380, filed on Apr. 2, 1997, entitled DIGITAL ELECTROCHROMIC MIRROR SYSTEM, now U.S. Pat. No. 6,089,721, issued on Jul. 18, 2000; and patent application Ser. No. 09/353,026, filed on Jul. 13, 1999, entitled DIGITAL ELECTROCHROMIC MIRROR SYSTEM, now U.S. Pat. No. 6,056,410, issued on May 2, 2000.

Various methods can be employed to achieve night-time display dimming including using a signal, typically a pulse-width modulated signal, from the vehicle that causes the mirror display to dim in tandem with the lights in the instrument panel. Another option is to use a mirror-mounted photosensor that causes the mirror-mounted display to dim when low ambient conditions are detected, such as is described in U.S. Pat. Nos. 5,416,313 and 5,285,060, the disclosures of which are incorporated by reference herein. Should the mirror mounted display be displaying from behind a window created in an electrochromic reflective element, then display re-brightening to compensate for any decrease in transmission of the electrochromic medium may be employed, such as is disclosed in U.S. Pat. Nos. 5,416,313 and 5,285,060.

Directional light-sensing means 20 includes an optic 40 and a photosensor array 42. Optic 40 is configured to generate a light pattern 44 that is generally planar in shape and which is directed to a different portion of photosensor array 42 dependent upon the direction that light is received by optic 40 (FIGS. 3-7). Photosensor 42 includes a plurality of photodetectors 46 that are spatially arranged on a substrate 48. Optic 40 may be oriented to generate a generally horizontal pattern of light 44′ that moves in a generally vertical direction dependent on the direction of light sensed by directional light-sensing means 20, as illustrated in FIG. 6. As such, photodetectors 46 may be vertically offset such that the location of pattern 44′ determines which one or ones of the photodetectors are intercepted by pattern 44′. Alternatively, optic 40 may be oriented to generate a generally vertical pattern 44″ which is moveable generally horizontally, as illustrated in FIG. 7, in order to intercept one or more photodetectors 46 as a function of the horizontal direction of the light intercepted by optic 40. It should be understood that optic 40 and photosensor array 42 may be configured to be responsive to both the horizontal and vertical direction of light sensed by the light-sensing means, as would be apparent to those skilled in the art. Optic 40, in the illustrative embodiment, is a cylinder plano-lens. However, other optics, including refractive and diffractive optics may be utilized.

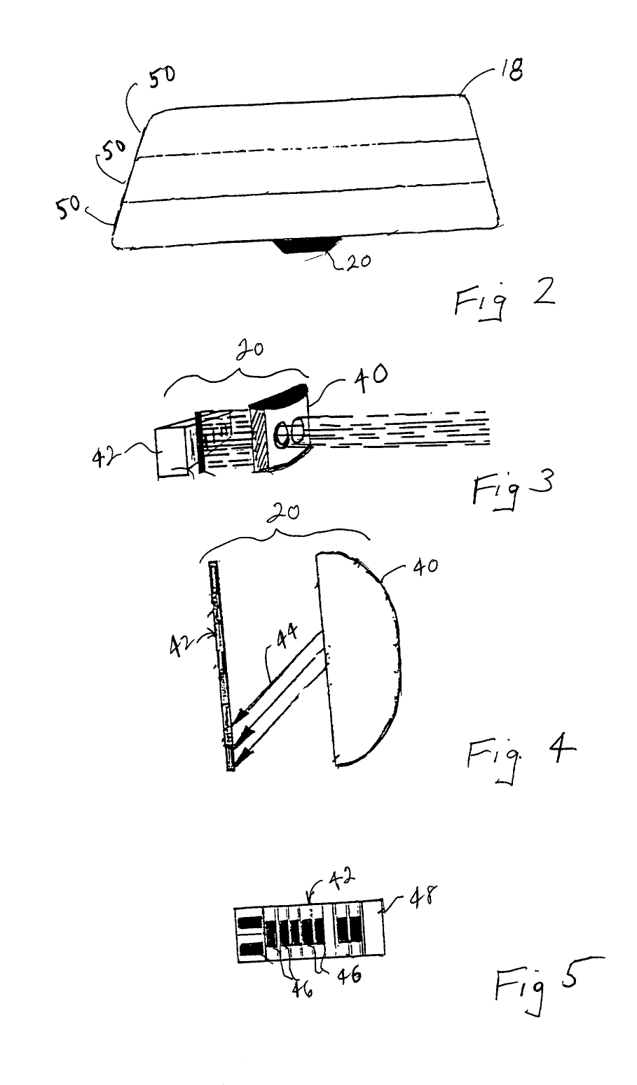

Vehicle rearview mirror system 10 further includes one or more reflective elements made up of a plurality of reflective element segments 50. As illustrated in FIG. 2, reflective element 18 is made up of a plurality of horizontal segments 50 that are vertically arranged across the reflective element of interior rearview mirror 18. One or more segments 50 are capable of assuming a partial reflectance level as a function of a drive signal on an output 34. As such, one or more segments 50 comprise an electro-optic mirror element which may be an electrochromic mirror element and, most preferably, an electrochemichromic reflective element, such as described in commonly assigned U.S. Pat. Nos. 5,140,455 and 5,151,816, or a solid-state electrochromic medium, such as described in the following publications: N. R. Lynam, “Electrochromic Automotive Day/Night Mirrors”, SAE Technical Paper Series 870636 (1987); N. R. Lynam, “Smart Windows for Automobiles”, SAE Technical Paper Series 900419 (1990); N. R. Lynam and A. Agrawal, “Automotive Applications of Chromogenic Materials”, Large Area Chromogenics: Materials and Devices for Transmittance Control, C. M. Lampert and C. G. Grandquist, EDS., Optical Engineering Press, Washington (1990), the disclosures of which are hereby incorporated by reference herein in their entireties. Other suitable electrochromic reflectors are described in U.S. Pat. Nos. 5,567,360; 5,525,264; 5,610,756; 5,406,414; 5,253,109; 5,076,673; 5,073,012 or 5,117,346, which are all commonly assigned to Donnelly Corporation, the disclosures of which are herein incorporated by reference in their entireties.

Typically, the two glass plates sandwich the electrochromic medium. A reflective coating may be deposited either on the rearmost surface away from the viewer (to create a fourth surface reflector as is known in the art) or disposed on the front surface of the rearmost substrate (to create a third surface reflector as is known in the art). The substrates can be of equal or different glass thickness. The electrochromic medium can be a liquid medium or a solid medium, such as a solid polymer matrix electrochromic medium, such as is disclosed in U.S. Pat. application Ser. No. 09/350,930, filed Jul. 12, 1999, entitled ELECTROCHROMIC POLYMERIC SOLID FILMS, MANUFACTURING ELECTROCHROMIC DEVICES USING SUCH FILMS, AND PROCESSES FOR MAKING SUCH SOLID FILMS AND DEVICES to Desaraju V. Varaprasad et al., the entire disclosure of which is hereby incorporated by reference herein. For example, an interior rearview mirror can comprise a 1.1 mm thick front substrate, a 2 mm thick rear substrate, and an aluminum silver, silver alloy, aluminum alloy, or the like, highly reflective metal film on the front surface of the rear substrate (i.e., third surface reflector) and the electrochromic medium may be solid, such as electrochromic Solid Polymer Matrix (SPM)™ comprising a color-changing cross-linked polymer solid film. Most preferably, the front substrate comprises a glass plate of thickness less than about 1.6 mm, most preferably about 1.1 mm thickness or lower, and the rear substrate comprises a glass plate of thickness equal to or greater than about 1.6 mm, more preferably greater than about 1.8 mm thickness, most preferably equal to or greater than about 2.0 mm thickness. The rearmost surface of the rear substrate (the fourth surface as known in the mirror art) is reflector-coated with a high-reflecting metal film, such as of aluminum or silver, or an alloy of aluminum or silver. Most preferably, the front-most surface of the rear substrate (the third surface as known in the mirror art) is reflector-coated with a high-reflecting metal film, such as of aluminum or silver, or an alloy of aluminum or silver.

When any given segment 50 dims to a first partial reflectance level, for example, to 10 percent reflectance, in response to a localized glare from headlights of a following vehicle, the segment 50 immediately adjacent on one side thereof and the segment immediately adjacent on the other side thereof also dims but to a higher partial reflectance level, such as 20 percent reflectance by way of example. This linking of partial, but lesser, dimming of immediately adjacent segments 50 through the segment principally reflecting the headlight glare, functions to a user appreciation of, and satisfaction with, operation of a multi-segment electro-optic mirror. Moreover, as the headlights of the following vehicle move across the mirror surface to either the one adjacent segment 50 or the other adjacent segment 50, the fact that the segment is already partially dimmed renders its dimming response time to a deeper level of dimming faster since the segment is already partially dimmed to begin with.

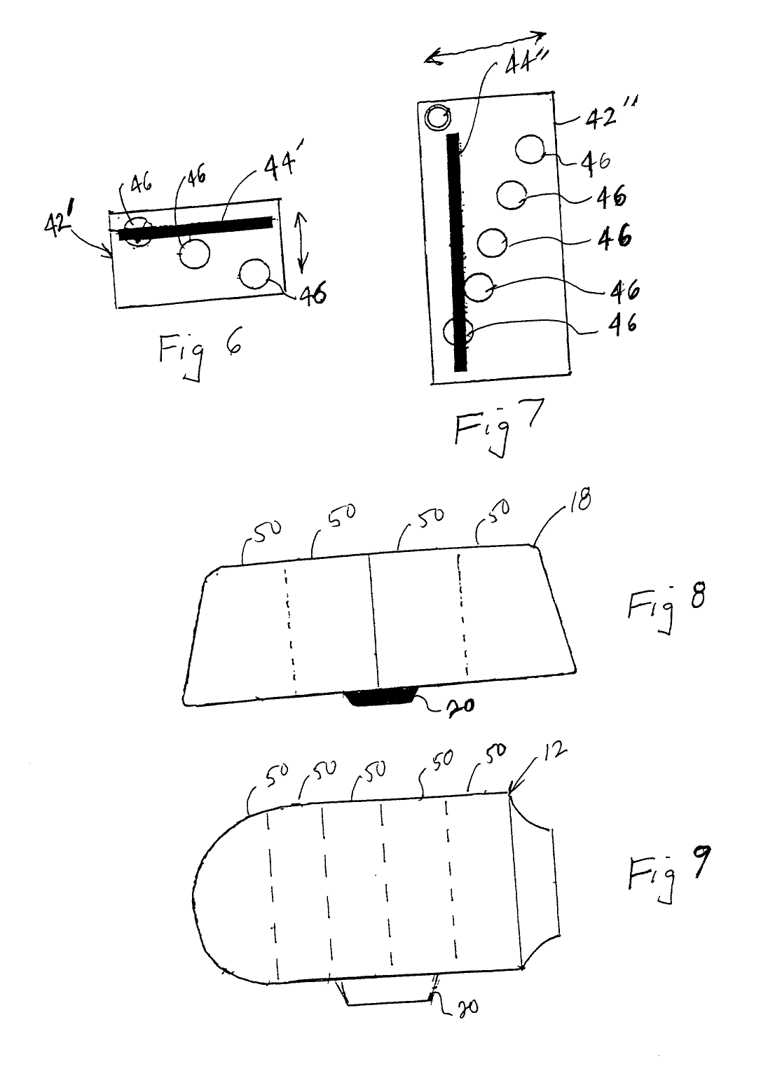

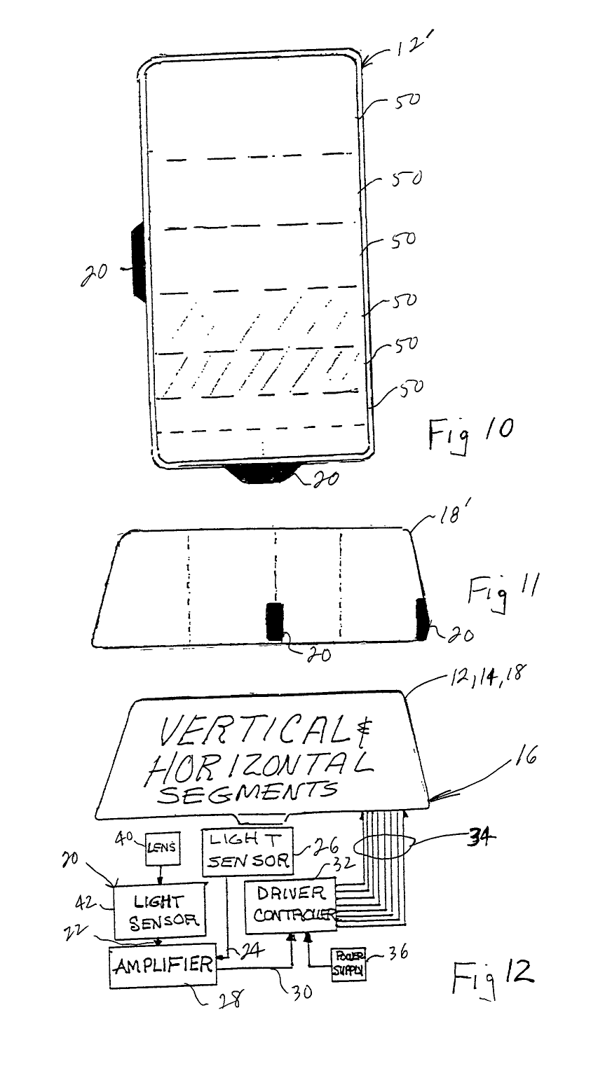

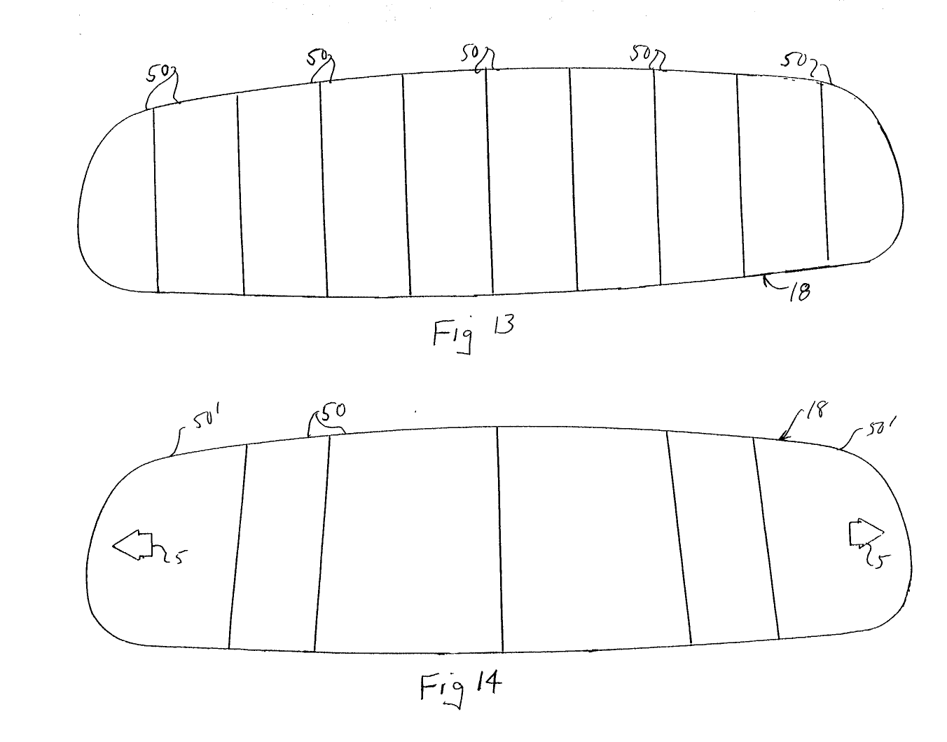

FIG. 8 illustrates a reflective element for interior rearview mirror assembly 18 that is divided into vertical segments 50 that are horizontally arranged across the reflective element thereof. A plurality of reflective element segments 50 may also be applied to driver side exterior rearview mirror assembly 12, as illustrated in FIG. 9, passenger side rearview mirror assembly 14, or both exterior rearview mirror assemblies 12, 14. As illustrated in FIG. 10, reflective element segments 50 may be equally or variably spaced. In FIG. 10, a driver side exterior mirror assembly 12′ is illustrated of the type that may be used on large trucks and vans.

Directional light-sensing means 20 may be positioned at various locations on rearview mirror assembly 12′ such as at a lower portion, side portion, upper portion, or the like. Only a lower portion and side portion are illustrated in FIG. 10. In FIG. 11, an interior rearview mirror assembly 18′ is illustrated in which directional sensing means 20 is positioned at a corner or center of the reflective element. Other positions may be used including mounting the directional sensing means to the interior mirror support, or mirror mount, or to a pod, or may be separately mounted, such as either above the interior rearview mirror assembly or below the interior rearview mirror assembly. Additionally, the directional sensing means may be mounted at an eyebrow at an upper portion of the interior rearview mirror assembly, or at a lip at a lower portion of the interior rearview mirror assembly.

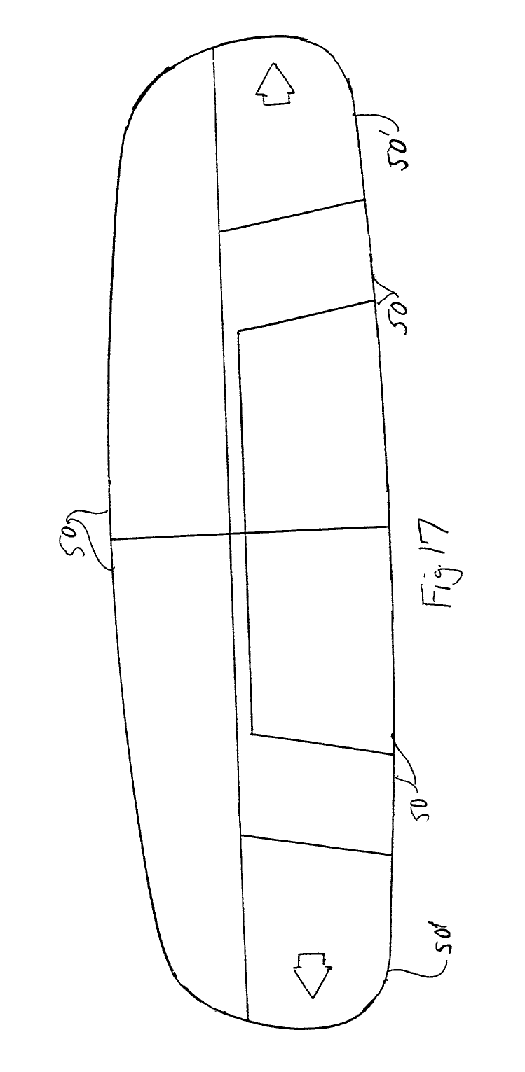

FIG. 13 illustrates interior rearview mirror assembly 18 with substantially evenly spaced vertical segments that are horizontally oriented across the mirror element. FIG. 14 illustrates an interior rearview mirror assembly 18 with uneven spacing of vertical segments 50. In outermost segments 50′, an indicia of another vehicle function, such as turn signals, are superimposed in outer segments 50′. Other information displays 55 such as PSIR (Passenger Side Inflatable Restraint) display and SIR (Side-Airbag Inflatable Restraint), compass/temperature display, a tire pressure status display, or other desirable displays, such as those disclosed in U.S. patent application Ser. No. 09/244,726, filed Feb. 5, 1999, the disclosure of which is hereby incorporated by reference herein, may be utilized. FIGS. 15-17 illustrate various configurations of interior rearview mirror assemblies 18 in which combination horizontal-vertical segments are utilized. It should be understood that the illustrations of FIGS. 15-17 may be equally applicable to exterior rearview mirror assemblies 12, 14.

The rearview mirror assemblies of the present invention can include a wide variety of electrical and electronic devices incorporated therein and further utility functions, such as described in co-pending application entitled “REARVIEW MIRROR ASSEMBLY WITH UTILITY FUNCTIONS”, filed Nov. 24, 1999, by Barry W. Hutzel, Niall R. Lynam, and Darryl P. DeWind, Attorney Docket DON01 P-778, which is hereby incorporated by reference herein in its entirety. For example, rearview mirror assemblies may include: antennas, including GPS or cellular phone antennas, such as disclosed in U.S. Pat. No. 5,971,552; a communication module, such as disclosed in U.S. Pat. No. 5,798,688; displays, such as shown in U.S. Pat. No. 5,530,240 or in U.S. pending application Ser. No. 09/244,726, filed Feb. 5, 1999; blind spot detection systems, such as disclosed in U.S. Pat. Nos. 5,929,786 or 5,786,772; transmitters and/or receivers, such as garage door openers, a digital network, such as described in U.S. Pat. No. 5,798,575; a high/low head lamp controller, such as disclosed in U.S. Pat. No. 5,715,093; a memory mirror system, such as disclosed in U.S. Pat. No. 5,796,176; a hands-free phone attachment, a video device for internal cabin surveillance and/or video telephone function, such as disclosed in U.S. Pat. Nos. 5,760,962 and 5,877,897; and co-pending application Ser. No. 09/433,467; a remote keyless entry receiver; map lights, such as disclosed in U.S. Pat. Nos. 5,938,321; 5,813,745; 5,820,245; 5,673,994; 5,649,756; or 5,178,448; microphones and/or speakers, such as disclosed in U.S. patent application Ser. Nos. 09/361,814, filed Jul. 27, 1999, and 09/199,907, filed Nov. 25, 1998; a compass, such as disclosed in U.S. Pat. No. 5,924,212; seat occupancy detector; a trip computer; an ONSTAR System, or the like, with all of the referenced patents and applications being commonly assigned to Donnelly Corporation, the disclosures of which are herein incorporated by reference in their entireties. Other features which can be incorporated include: a baby minder system, such as the vehicle interior monitoring system described in U.S. Pat. Nos. 5,877,897 and 5,760,962 or the rear vision system described in pending U.S. patent applications Ser. No. 09/361,814, filed Jul. 27, 1999, and Ser. No. 09/199,907, filed Nov. 25, 1998, and U.S. patent application Ser. No. 09/422,467 (Attorney Docket No. P-783) filed Nov. 4, 1999 entitled VEHICLE INTERIOR MIRROR ASSEMBLY to Patrick Heslin and Niall R. Lynam, all of which are incorporated by reference in their entireties herein.

Furthermore, the mirror assemblies of the present invention may incorporate a navigation system, such as described in co-pending provisional application Ser. No. 60/131,593, filed Apr. 29, 1999, entitled VEHICLE-BASED NAVIGATION SYSTEM WITH SMART MAP FILTERING, PORTABLE UNIT HOME-BASE REGISTRATION AND MULTIPLE NAVIGATION SYSTEM PREFERENTIAL USE, which is herein incorporated by reference in its entirety. Alternately or in addition, the modular aspects of the present invention can be combined with or incorporate a wide variety of other interior rearview mirror assemblies including electrically operated compass mirrors such as disclosed in U.S. Pat. No. 5,253,109; electrically operated interior rearview mirrors incorporating map reading lights such as disclosed in U.S. Pat. Nos. 4,646,210; 4,733,336; 4,807,096; and 5,178,448; and electrically operated automatically dimming mirrors such as described in U.S. Pat. Nos. 4,793,690; 4,799,768; 4,886,960; and 5,193,029; mirror assemblies incorporating GPS such as disclosed in patent application Ser. No. 08/569,851, filed Dec. 8, 1995, by Roger L. Veldman and Desmond O'Farrell for A VEHICLE GLOBAL POSITIONING SYSTEM NAVIGATIONAL AID; mirrors including head light controls, such as disclosed in U.S. patent application Ser. No. 08/621,863, filed Mar. 25, 1996, entitled VEHICLE HEADLIGHT CONTROL USING IMAGING SENSOR; mirrors incorporating displays, such as disclosed in U.S. patent application Ser. No. 09/244,726, filed Feb. 5, 1999, entitled REARVIEW MIRROR ASSEMBLY INCORPORATING VEHICLE INFORMATION DISPLAY and U.S. Pat. No. 5,530,240 for DISPLAY FOR AUTOMATIC REARVIEW MIRROR; mirrors incorporating blind spot detection systems, such as disclosed in U.S. Pat. No. 5,530,240; U.S. Pat. No. 5,576,687; and U.S. patent application Ser. No. 08/799,735, entitled VEHICLE BLIND SPOT DETECTION AND DISPLAY SYSTEM, filed Feb. 12, 1997; and mirrors incorporating remote transaction systems, such as disclosed in U.S. Pat. application Ser. No. 09/057,428, filed Apr. 8, 1998, for A VEHICLE MOUNTED REMOTE TRANSACTION INTERFACE SYSTEM; and U.S. Pat. No. 5,798,575; all commonly assigned to Donnelly Corporation, Holland, Mich. and the disclosures of which are herein incorporated by reference in their entireties.

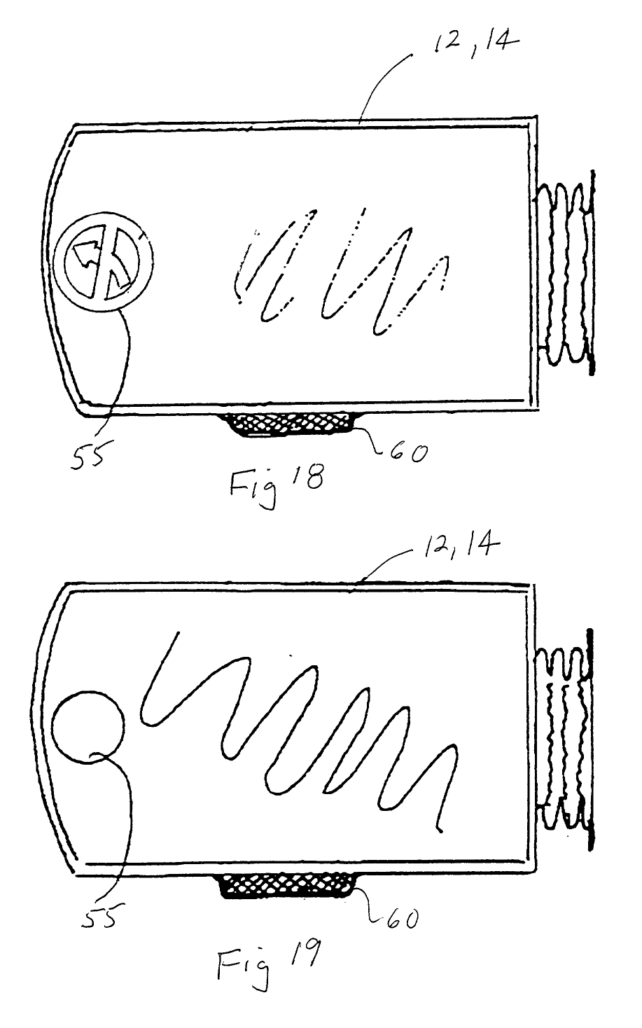

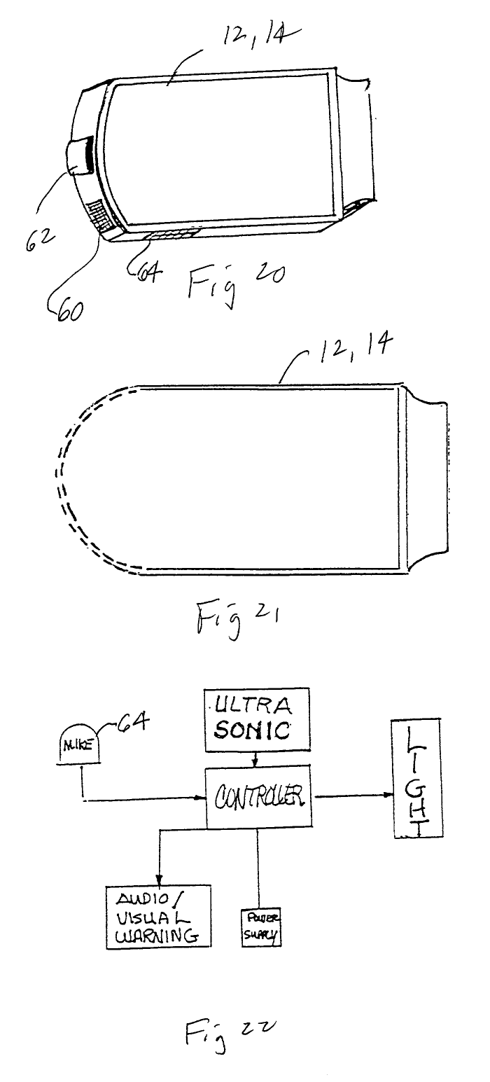

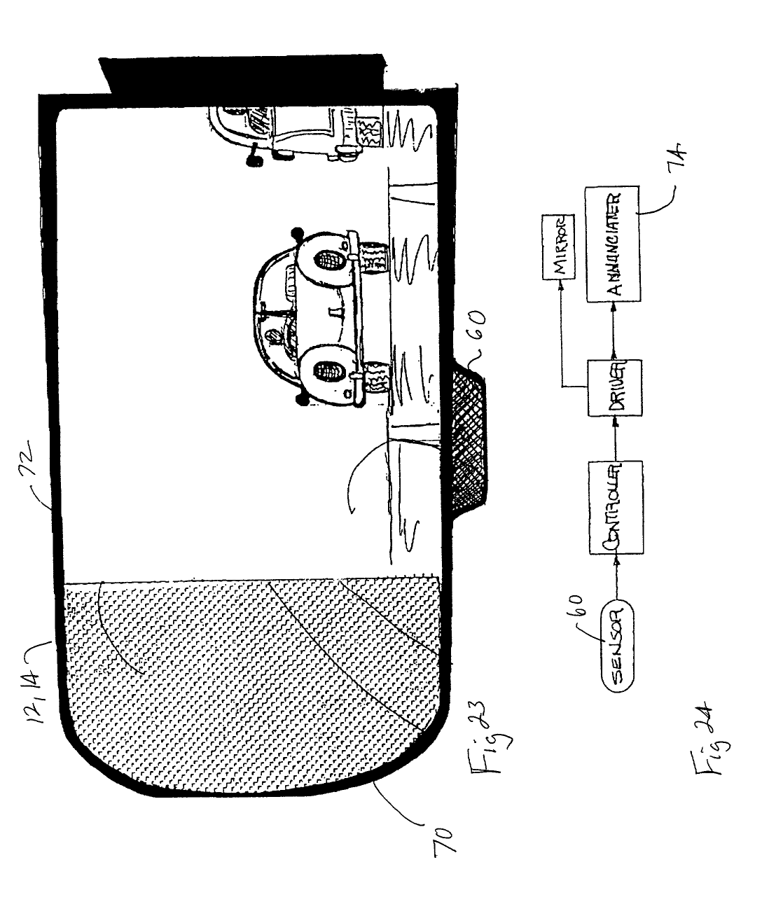

The invention may be used with a blind spot detector 60 such as a Doppler radar, ultrasonic transducer, camera system with image recognition, infrared photo-transceiver, or the like (FIGS. 18-25). One or both exterior mirror assemblies 12, 14 may be equipped with a symbol 55 when traffic, as sensed by blind spot detector 60, is in the blind spot area of the vehicle. The traffic symbol 55 is extinguished, as illustrated in FIG. 19, when blind spot detector 60 does not detect the presence of traffic in the vicinity of the vehicle.

In FIG. 20, exterior rearview mirror assembly 12, 14 is equipped with a signal generator 62 which may be a light generator, an aural signal generator, or the like. Signal generator 62 is actuatable by a blind spot detection device 60. As another vehicle passes the equipped vehicle, sensor 60 switches on signal generator 62 which projects outwardly of the equipped vehicle through the blind spot zone. The signal projection angle would be such as to reflect off of not only an automobile, but also a truck, recreational vehicle body surface, and the like. The transmitter and receiver would be angled in such a way as to have the appropriate bounce back through the blind spot zone irrespective of the sensed vehicle. Alternatively, a manual device could be used as well to activate signal device 62. Such manual device would be mounted within easy reach of the driver, such as on the steering wheel, turning wand, or foot switch. A microphone 64 may be located in external mirror assembly 12, 14 to detect emergency responder vehicles and alert the driver of the equipped vehicle either visually or aurally, or both, that such an emergency vehicle is in the immediate area and would drive all of the mirror assemblies to a high reflectance condition. The alert could be a visible signal, such as an LED in the visual scan of the driver, or a reproduction of the actual outside alert sounds. The alert could also trigger a separate alarm for the driver. Also, when flashing lights are picked up by any other device, the controller would drive all of the mirror elements to a high reflectance condition.

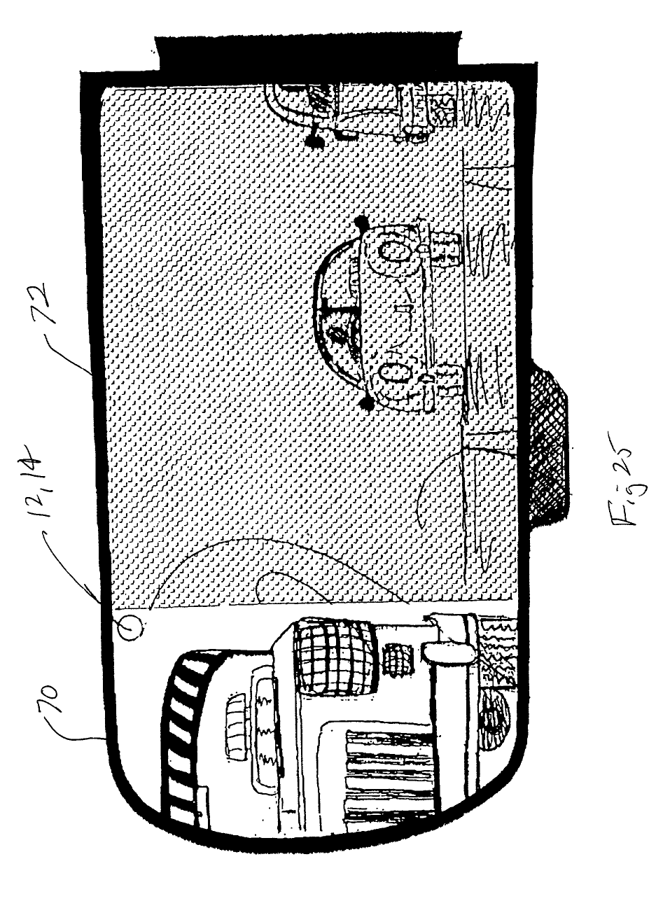

In FIG. 23, exterior rearview mirror assembly 12, 14 is made up of two sections 70, 72. Both sections 70, 72 are capable of being driven to a partial reflectance level. Section 70 is made in a fixed position at an angle sufficient to image in the blind spot zone of the equipped vehicle. Section 72 is angled at a typical rearview mirror imaging position. A blind spot detector 60 responds to the detection of a vehicle and the blind spot of the equipped vehicle by causing mirror section 70 to be driven to a high reflectance state and to slightly tint segment 72 in order to enhance contrast with section 70. An enunciator 74 may additionally draw the attention of the driver to the presence of traffic in the vehicle's blind spot.

Changes and modifications in the specifically described embodiments can be carried out without departing from the principles of the invention which is intended to be limited only by the scope of the appended claims, as interpreted according to the principles of patent law including the doctrine of equivalents.

The embodiments of the invention in which an exclusive property or privilege is claimed are defined as follows:

1. A vehicular rearview mirror system, comprising:
a rearview mirror assembly, said rearview mirror assembly comprising a reflective element and a mirror housing for said reflective element;
said reflective element comprising a plurality of reflective element segments, at least one of said reflective element segments comprising an electro-optic variable reflective element having a partial reflectance level that varies as a function of a drive signal; and
directional light-sensing means for producing an output that varies as a function of a direction that light is sensed by said light-sensing means, said output providing a drive signal to said at least one of said reflective element segments, wherein said at least one of said reflective element segments has a partial reflectance level that is a function at least of direction that light is sensed by said light-sensing means.

2. The vehicle rearview mirror system in claim 1 wherein at least two of said reflective element segments comprise electro-optic variable reflective elements and wherein said light sensor provides separate drive signals to said at least two of said reflective element segments, wherein said at least two of said reflective element segments can be at different partial reflectance levels.

3. The vehicle rearview mirror system in claim 1 wherein said reflective element segments are vertical segments that are horizontally arranged across said interior reflective element.

4. The vehicle rearview mirror system in claim 3 wherein said reflective element segments have a substantially uniform horizontal dimension.

5. The vehicle rearview mirror system in claim 3 wherein said reflective element segments have horizontal dimensions that are a function of the location of the particular segment in the interior reflective element.

6. The vehicle rearview mirror system in claim 1 wherein said reflective element segments are horizontal segments that are vertically arranged across said interior reflective element.

7. The vehicle rearview mirror system in claim 6 wherein said reflective element segments have a substantially uniform vertical dimension.

8. The vehicle rearview mirror system in claim 6 wherein said reflective element segments have vertical dimensions that are a function of the location of the particular segment in the interior reflective element.

9. The vehicle rearview mirror system in claim 1 wherein said reflective element segments are combination vertical and horizontal segments that are horizontally and vertically arranged across said interior reflective element.

10. The vehicle rearview mirror system in claim 1 wherein said reflective element segments comprise at least three segments.

11. The vehicle rearview mirror system in claim 10 wherein said reflective element segments comprise at least five segments.

12. The vehicle rearview mirror system in claim 1 wherein said control coordinates the reflectance level of said segments.

13. The vehicle rearview mirror system in claim 12 wherein said control coordinates the reflectance levels of adjacent said segments to vary from each other by no more than a given amount.

14. The vehicle rearview mirror system in claim 13 wherein said given amount is 10%.

15. The vehicle rearview mirror system in claim 1 wherein said directional light sensor comprises a directional lens and a photo sensor array.

16. The vehicle rearview mirror system in claim 15 wherein said directional lens comprises a cylindrical plano-lens.

17. The vehicle rearview mirror system in claim 15 wherein said photo sensor array is comprised of overlapping photo sensor units.

18. The vehicle rearview mirror system in claim 1 further including another rearview mirror assembly comprising another reflective element and another mirror housing for said another reflective element, said another reflective element comprising a plurality of other reflective element segments, at least one of said other reflective element segments comprising an electro-optic variable reflective element having a partial reflectance level that varies as a function of a drive signal, and wherein said at least one of said other reflective element segments having a partial reflectance level that varies as a function of a direction that light is sensed by said directional light-sensing means.

19. The vehicle rearview mirror system in claim 18 wherein said rearview mirror assembly comprises an interior rearview mirror assembly and said reflective element comprises an interior reflective element and further wherein said another rearview mirror assembly comprises an exterior rearview mirror assembly and said another reflective element comprises an exterior reflective element.

20. The vehicle rearview mirror system in claim 19 wherein said exterior rearview mirror assembly comprises a driver side mirror assembly.

21. The vehicle rearview mirror system in claim 19 wherein said exterior rearview mirror assembly comprises a passenger side mirror assembly.

22. The vehicle rearview mirror system in claim 1 wherein said rearview mirror assembly comprises an exterior rearview mirror assembly and said reflective element comprises an exterior reflective element.

23. The vehicle rearview mirror system in claim 22 wherein said exterior rearview mirror assembly comprises a driver side mirror assembly.

24. The vehicle rearview mirror system in claim 22 wherein said exterior rearview mirror assembly comprises a passenger side mirror assembly.

25. The vehicle rearview mirror system in claim 18 wherein said directional light-sensing means comprises a directional light sensor at said rearview mirror assembly and another directional light sensor at said another rearview mirror assembly.

26. The vehicle rearview mirror system in claim 18 wherein said other reflective element segments are vertical segments that are horizontally arranged across said exterior reflective element.

27. The vehicle rearview mirror system in claim 18 wherein said other reflective element segments are horizontal segments that are vertically arranged across said exterior reflective element.
